(19) United States
(12) Patent Application Publication
(10) Pub. No.: US 2003/0028632 A1
(43) Pub. Date: Feb. 6, 2003

(54) System and method of multicasting data messages

(76) Inventor: Thomas G. Davis, Durham, NC (US)

Correspondence Address: Pillsbury Winthrop LLP, Intellectual Property Group, 50 Fremont Street, San Francisco, CA, 94105, US

(21) Appl. No.: 09/921,855

(22) Filed: Aug. 2, 2001

(51) Int. Cl. G06F 15/173

(52) U.S. Cl. 709/224; 709/203

(57) ABSTRACT

A system and method of logging multicast data messages in a communication network implement data logging methodologies mapped onto a multicast architecture exploiting the efficiencies inherent in multicasting techniques. A multicast logging system may include one or more Log Clients publishing log reports to one or more multicast addresses, one or more Log Servers subscribing to one or more multicast addresses and persisting selected log data, and a Log Viewer presenting a real-time view of log traffic directed to one or more multicast addresses. A method of logging multicast messages may incorporate such a system arrangement. Additionally, alarm messages comprising critical system data may be multicast using the foregoing system architecture and functionality.

### BACKGROUND

1. Field of the Invention

Aspects of the present invention relate generally to data logging in a network environment, and more particularly to a system and method of logging multicast data messages transmitted across a communications network.

2. Description of the Related Art

Recent advances in Internet Protocol (IP) data transmission techniques and wireless communications technologies have led to increasing popularity of internet-based telephony and various other packet-switched data communications services. Conventional systems have proposed internet-enabled, or web-enabled, interfaces which are capable of managing packet-based or IP-based voice and data communications. These systems typically enable IP or web communications services through implementation of a plurality of servers, i.e. server-side processing hardware and software operative for initiation and management of various network transactions. Conventional server-based processing platforms support multicast data traffic (i.e. point-to-multipoint or multipoint-to-multipoint communication models); data may be multicast, or published, from one or more sources to multiple destinations or subscribers.

Further, techniques for logging selected information related to particular data transmissions or the operation of particular software applications or hardware devices are generally known in the art. Typical logging techniques may record certain system events, network transactions, or software application information and write non-critical or diagnostic data to a file or other data structure for subsequent analysis. Current implementations, however, have failed to optimize system resources through integration of multicasting architectures and techniques into a comprehensive logging strategy.

For example, many applications, including network-based applications, have either abandoned logging functionality or have sacrificed performance to support it; since system resources available for the application's primary function are depleted by the commitment of processing capacity to the logging operation, logging transaction or diagnostic data adversely affects the performance of the application engaged in the network transaction. In addition to the logging operation creating a drain on system resources, traditional unicast transmission techniques are inefficient as described below.

For a publishing application to transmit the same data to multiple subscribing applications through a unicast socket, such as Transmission Control Protocol (TCP) or User Datagram Protocol (UDP), for example, the publishing application is required to transmit a different message to every subscriber; this unicast strategy creates a severe processing overhead penalty which degrades system performance, often to the point of system failure. Multicast strategies solve such system overhead problems by allowing the network and data link layers of the network protocol stack to duplicate transmitted data only where required. As a consequence, the multicast publisher may be completely unaffected by the number of subscribing applications, and the system is essentially infinitely scalable, i.e. the number of subscribing applications may be unlimited. Additionally, since multicast transactions are connectionless, multicast transmissions do not require the publishing application to remain idle in the manner required by such protocols as TCP/IP.

### BRIEF DESCRIPTION OF THE DRAWINGS

FIG. 1 is a simplified high-level block diagram illustrating a data communication network environment in which an embodiment of a system and method of multicast logging may be employed.

FIG. 2 is a simplified high-level block diagram illustrating one embodiment of a multicast logging system.

FIG. 3 is a simplified high-level block diagram illustrating a server architecture supporting one embodiment of a redundant, fault-tolerant multicast logging system.

FIG. 4 is a simplified flow diagram illustrating one embodiment of a method of logging multicast data messages in a communication network.

### DETAILED DESCRIPTION

As noted briefly above, traditional systems have not mapped logging strategies onto a multicasting architecture. There is a continuing and growing need for a system and method employing best-effort logging functionality which simultaneously exploit the efficiencies of multicasting technology and minimize performance penalties for integrated network applications.

Embodiments of the present invention overcome various shortcomings of conventional technology, providing a system and method of logging multicast data messages transmitted across a communications network. In accordance with one aspect of the present invention, a multicast logging system and method implement data logging methodologies mapped onto a multicast architecture enabling full utilization of the efficiencies inherent in multicasting techniques.

The foregoing and other aspects of various embodiments of the present invention will be apparent through examination of the following detailed description thereof in conjunction with the accompanying drawings.

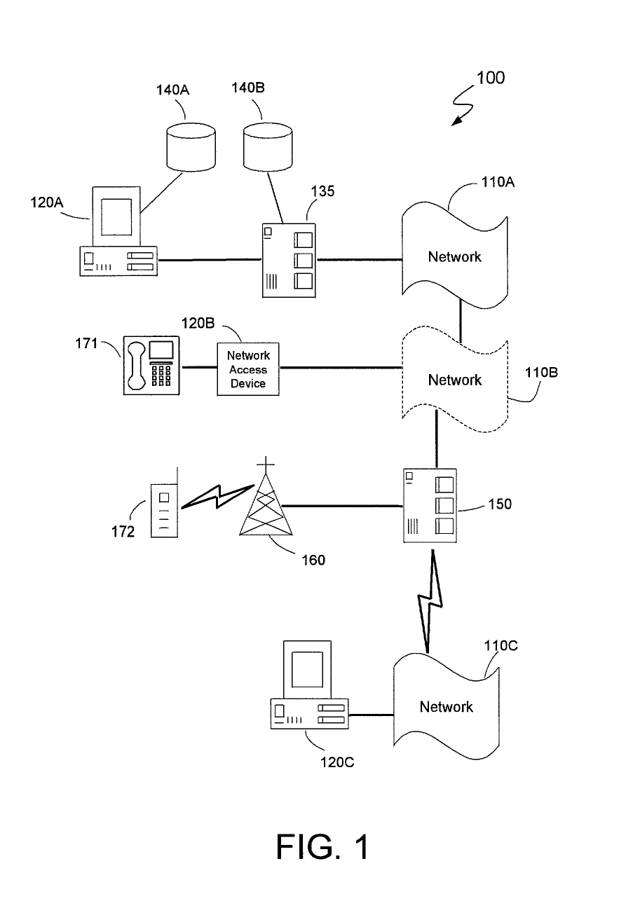

Turning now to the drawings, FIG. 1 is a simplified high-level block diagram illustrating a data communication network environment in which an embodiment of a system and method of multicast logging may be employed. A network system 100 may be configured to facilitate packet-switched data transmission of text, audio, video, Voice over Internet Protocol (VoIP), multimedia, and other data formats known in the art. System 100 may operate in accordance with various networking protocols, such as Transmission Control Protocol/Internet Protocol (TCP/IP), Hypertext Transfer Protocol (HTTP), Simple Mail Transfer Protocol (SMTP), Asynchronous Transfer Mode (ATM), Real-time Transport Protocol (RTP), Real-time Streaming Protocol (RTSP), Session Announcement Protocol (SAP), Session Description Protocol (SDP), and Session Initiation Protocol (SIP). Those of skill in the art will appreciate that a system and method of multicast logging may be employed in conjunction with numerous other protocols accommodating packet-switched data transmission known in the art, such as H.323 and MGC3, for example, or developed and operative in accordance with known principles.

Network access devices 120A-120C may be coupled via one or more communications networks 110A-110C enabling data communication between and among network access devices 120A-120C as described in detail below. Additionally, network access devices 120A-120C may be coupled with peripheral devices such as, inter alia, a telephone 171 or wireless telephone 172. Those of skill in the art will appreciate that network access devices 120A-120C and any attendant peripheral devices may be coupled via one or more networks 110A-110C as illustrated in FIG. 1.

In some embodiments, for instance, network access device 120A-120C may be personal desktop or laptop computers, workstations, personal digital assistants (PDAs), personal communications systems (PCSs), wireless telephones, or other network-enabled devices. The scope of the present disclosure is not limited by the form or constitution of network access devices 120A-120C; any apparatus known in the art which is capable of data communication on networks 110A-110C is within the scope and contemplation of the inventive system and method.

Each individual network 110A-110C may also include or be coupled, either directly or indirectly, to other networkable devices known in the art in addition to one or more of the following, for example: storage media 140A and 140B; application server 135; telephone network server 150; and wireless telephone base station 160. It is well understood in the art that any number or variety of computer networkable devices or components may be coupled to networks 110A-110C without inventive faculty. Examples of other devices include, but are not limited to, the following: servers; computers; workstations; terminals; input devices; output devices; printers; plotters; routers; bridges; cameras; sensors; or any other networkable device known in the art.

A network 110A-110C may be any communication network known in the art, including the Internet, a local area network (LAN), a wide area network (WAN), a virtual private network (VPN), or any similarly operating system linking network access devices 120A-120C and similarly capable equipment. Further, networks 110A-110C may be configured in accordance with any topology known in the art such as, for example, star, ring, bus, or any combination thereof. In operation, networks 110A-110C may generally enable unicast and multicast network transactions, i.e. two-way point-to-point, point-to-multipoint, or multipoint-to-multipoint data transfer between and among network access devices 120A-120C.

Application server 135 may be connected to network 110A which supports receipt and transmission of data packets. Telephone network server 150 may be configured to allow two-way data communication between different networks, such as networks 110B and 110C as depicted in FIG. 1. Additionally or alternatively, telephone network server 150 may communicate with a public-switched telephone network (PSTN), a plain old telephone service (POTS) network, an Integrated Services Digital Network (ISDN), a private branch exchange (PBX) telephone switchboard, or any other telephone network. As illustrated in FIG. 1, telephone network server 150 may be coupled to wireless base station 160, which supports two-way communication between telephone network server 150 and wireless telephone 172.

As used herein, the term “unreliable data” refers to data packets, messages, or parts thereof which are allowed to be inaccurate or lost, i.e. where the system allows unreliable data transmission, neither error identification nor correction is required. Conversely, “reliable data” refers to data packets, messages, or parts thereof which must be error-free; accordingly, where the system requires reliable data transmission, error detection and correction techniques must be employed.

Transmission of unreliable data across network system 100 typically consumes fewer system resources than transmission of reliable data; consequently, with respect to bulk data, unreliable data delivery may be as great as two orders of magnitude faster than reliable data delivery. Reliable multicast techniques are known in the art, and are generally preferable to unicast TCP/IP as noted above, since the multicast publisher is required to transmit only a single multicast message, rather than an independent message for each subscriber.

By way of example, a system and method of multicast logging may be implemented at, or incorporated in, a single computer server such as telephone network server 150 or application server 135, for example. Additionally or alternatively, some or all of the functionality described in detail below may be incorporated into a plurality of distributed servers situated on, or operatively coupled to, one or more of networks 110A-110C.

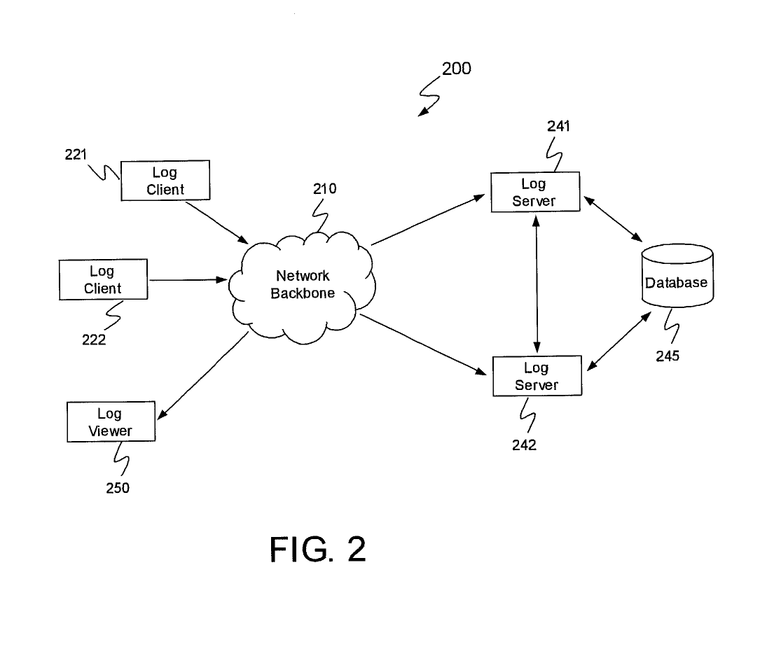

FIG. 2 is a simplified high-level block diagram illustrating one embodiment of a multicast logging system implemented in a data communication network environment. The FIG. 2 embodiment may exploit features inherent in existing network architectures and multicasting technologies. For example, a system and method of multicast logging may selectively replicate data at the data link layer or the network layer of the Open Systems Interconnect (OSI) network protocol model only when needed.

Additionally, multicast data may be selectively assigned a geographical scope such that its distribution across network routers may be controlled. For example, the geographic scope of data may be limited or restricted to a single machine or to parts of a local network or a broader network as described below; alternatively, data may be unrestricted, or global, in geographic scope. Further, as is generally recognized as a feature of multicasting, a multicast data publisher may not be penalized for the number of subscribing clients or applications in a multicast group.

The multicast logging system 200 illustrated in FIG. 2 generally comprises the following: one or more Log Clients 221 and 222, which may publish messages to one or more multicast addresses; one or more Log Servers 241 and 242, which may subscribe to one or more multicast addresses and persist selected data (for example, in a database 245 or other storage medium) transmitted to such multicast addresses; and, optionally, a Log Viewer 250, which may present a real-time view of log traffic directed to one or more multicast addresses.

The foregoing system components (Log Clients 221, 222, Log Servers 241, 242, database 245, and Log Viewer 250) may generally reside on a single physical machine or network server, for example; additionally or alternatively, one or more of the system components, embodied in software or firmware modules, for example, may reside on a plurality of distributed physical machines as generally depicted in FIG. 2, provided that two-way data communication between and among system components is enabled via a Network Backbone 210. Those of skill in the art will appreciate that the number of hardware or software components employed by a system such as illustrated in FIG. 2 may be increased as desired; such scalability may enable system 200 to expand sufficiently to accommodate desired data logging throughput and fault tolerance as set forth below.

Multicast Network Backbone 210 may generally correspond to Networks 110A, 110B, and 110C described above, and may be constituted by routers, network interfaces, and the like, as is common in the art. Accordingly, Network Backbone 210 may generally represent a plurality of distributed physical machines as discussed above with reference to FIG. 1.

Log Clients 221 and 222 may publish multicast messages to the network. By way of example, Log Client 221, 222 may be a small programming routine or module incorporated into a larger software application; alternatively, Log Client 221, 222 may represent any software application, firmware instruction set, or hardware code, or any combination thereof, adapted to publish log reports to Network Backbone 210. Log Client 221, 222 may generate logs as is generally known in the art, and publish the log reports to be received by multicast subscribers. The published logs may be transmitted to a multicast address in the form of User Datagram Protocol (UDP) data packets, for example.

In operation, the UDP protocol does not guarantee that a data message will be delivered (i.e. the data transmission may be unreliable, resulting in data loss or error upon reception), nor does the protocol even require a connection. Consequently, if reliable data publication is required or desired, and the system is operative in accordance with a protocol such as UDP, the publishing application program or other software or firmware represented by the transmitting Log Client 221, 222 may execute error processing or multicast message retransmission techniques.

If unreliable data transmission is acceptable (i.e. some data may be lost), then no additional processing load is placed on the transmitting Log Client 221, 222 regardless of the number of subscribers to that data. On the other hand, where the data must be reliable, the transmitting Log Client 221, 222 itself may implement reliable multicast transport techniques such as error processing or selective retransmission as noted above.

As noted briefly above, error processing or retransmission operations may adversely impact overall performance of transmitting Log Client 221, 222; on the other hand, even the reliable multicasting techniques implemented by Log Client 221, 222 may generally require less system overhead than would be required to implement a plurality of unicast connections. Additionally, Log Viewer 250 may be implemented to accept unreliable data, irrespective of the reliability requirements of other system components. In an embodiment employing such selective reliability for various components, processing overhead for a transmitting Log Client 221, 222 may generally not be affected by operation of Log Viewer 250.

Log Servers 241, 242 may be enabled to receive multicast packets (such as the UDP packets described above) from one or more Log Clients 221, 222 through Network Backbone 210. In that regard, Log Servers 241, 242 may join or be assigned to one or more multicast groups, ie. Log Servers 241, 242 are subscribers to one or more multicast addresses, to facilitate reception of multicast messages published to those groups or addresses. In such an embodiment, the actual volume of data packets per unit time which are transmitted to multicast addresses to which a particular Log Server 241, 242 is subscribed may generally affect the load experienced at that Log Server 241, 242 to a greater extent than the number of Log Clients 221, 222 publishing to those addresses.

Published log reports received at Log Servers 241, 242 may be written to one or more data storage media, such as database 245, in raw form for subsequent retrieval and analysis; additionally or alternatively, some or all of the data provided in log reports may be processed in whole or in part, for example, before data are written to database 245.

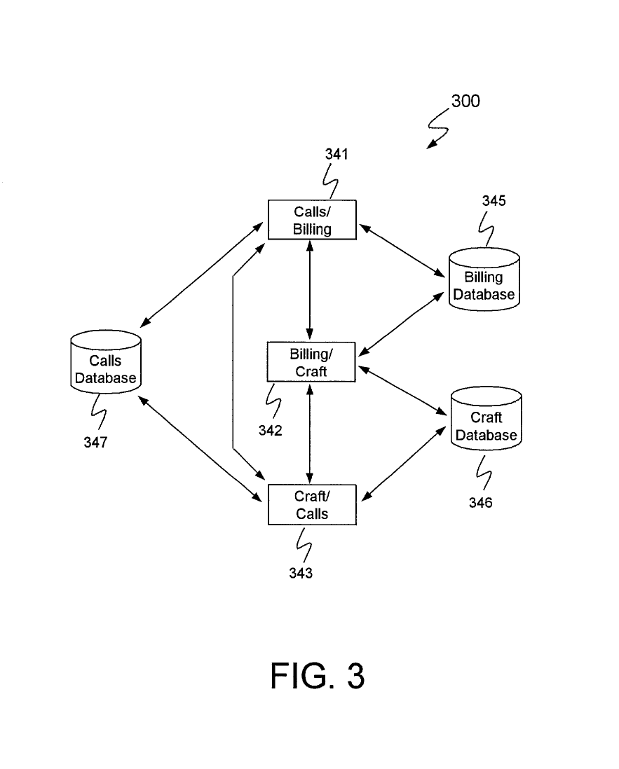

Log Servers 241, 242 may implement reliable multicast transport techniques such as error processing, for example, to facilitate overall system operation in accordance with desired or required data reliability standards. Further, as indicated in FIG. 2, inter-server data communication, heartbeat or timestamp signaling, and other techniques may be employed between and among Log Servers 241, 242, providing desired or required redundancy and fault tolerance as set forth below with reference to FIG. 3.

Log Viewer 250 may be a console application, for example, capable of displaying log messages in real-time or near real-time, such as upon receipt; additionally or alternatively, Log Viewer 250 may enable transmission of log data to a remote device such as a printer, a plotter, or the like. Log Viewer 250 may be embodied in a Java(™) applet, for example, or other programming code incorporated into a conventional World Wide Web browser, that may display or print logs; additionally or alternatively, Log Viewer 250 may examine published log messages to identify the occurrence of certain system or network events. In some embodiments, as noted above, data reliability may not be required for multicast messages transmitted to Log Viewer 250.

As noted above, Log Viewer 250 may generally be considered an optional component of multicast logging system 200. In an embodiment omitting Log Viewer 250, one or more Log Servers 241,242 may incorporate some or all of the functionality described above, i.e. enabling real-time viewing or printing of log report data through a console application. Conversely, Log Servers 241, 242 and database 245 may be omitted from system 200. In such an alternative embodiment, Log Viewer 250 may represent the only component in system 200 subscribing to multicast log reports, and may further enable transmission of log report data, for example, to a data storage medium or to another terminal or server having data storage capability.

The FIG. 2 embodiment may support different strategies for meeting system scalability requirements. With respect to hardware scalability in the FIG. 2 multicast logging system 200, for example, each Log Client 221, 222 and Log Server 241, 242 may exist on a single independent physical machine, or each may be distributed across a plurality of physical machines as described above. Such a strategy of hardware distribution may be transparent to a publishing or a subscribing application program, and may support seamless and efficient redistribution of any system component at any time.

With respect to software scalability, some embodiments may employ multicast address categorization supporting creation of meaningful multicast groups (i.e. address/port combinations). Systems and methods employing such multicast address categorization techniques may create prioritized and categorized message portals. For example, a Log Client 221, 222 may publish data messages to any number of groups; similarly, a Log Server 241, 242 may subscribe to, i.e. receive messages published to, any number of groups. In an embodiment operating in the foregoing manner, a Log Server 241, 242 may distribute processing tasks across a plurality of independent physical machines, for example. Distribution or load balancing, for instance, may be achieved by selectively directing messages published to one or more particular groups to a particular physical machine for processing, while selectively directing other messages to other physical machines.

FIG. 3 is a simplified high-level block diagram illustrating a server architecture supporting one embodiment of a redundant, fault-tolerant multicast logging system. Since multicast publishing may generally be a connectionless transmission, a multicast publisher need not be apprised of the actual addresses or locations of particular subscribers; such inherent characteristics of multicasting techniques and the server arrangement in FIG. 3 may enable some embodiments of a multicast logging system to implement redundancy and failure recovery strategies as described below.

As illustrated in FIG. 3, a redundant, fault-tolerant embodiment may be based upon a server architecture 300 comprising two or more Log Servers 341-343. Log Servers 341-343 may generally correspond to Log Servers 241, 242 described in detail above with reference to FIG. 2. For each multicast group subscription, one Log Server 341-343 may be designated as a primary server, while a different Log Server 341-343 may be designated as a secondary server. Additionally, Log Servers 341-343 may cooperate to maintain a common data store, such as databases 345-347, for example, in which to persist the log reports, data derived from the log reports, or a combination of both.

In operation, both the primary and the secondary log servers may receive data packets addressed to designated multicast groups; incoming data packets may generally be queued, buffered, or otherwise stored temporarily at Log Servers 341-343, for example, until an adequate block is ready to be persisted in databases 345-347. The primary server may persist the data block and send an interrupt, heartbeat signal, simple data message, or other similar indication, to notify the secondary server that the data block has been persisted. When such an indication has been received, i.e. the secondary server has been apprised that the data has been persisted, the secondary server may free that data block from the queue or buffer. Alternatively, if the secondary server does not receive such a heartbeat signal after a predetermined time interval, for example, then the secondary server may consider the primary server as having failed; in such a situation, the secondary server may become the primary server and persist the most recent data block.

In the foregoing example, categorizing the log data across a plurality of multicast groups enables an arrangement of multiple servers to handle all incoming data logs while providing seamless fault recovery, or hot fail over.

In the FIG. 3 embodiment, for example, three Log Servers 341-343 and three databases 345-347 are employed, though the system is scalable as described above to include any appropriate or desired number of servers or databases. Each Log Server 341-343 may be designated to process two log types. For example: Log Server 341 may be designated as the primary server for log reports related to the “Calls” category, and the secondary server for log reports related to the “Billing” category; Log Server 342 may be designated as the primary server for “Billing” category logs, and the secondary server for “Craft” category logs; while Log Server 343 may be designated as the primary “Craft” server and the secondary “Calls” server. The overlapping log category model shown in FIG. 3 may generally distribute incoming data packet loads across multiple servers while providing fault tolerance in the case of server failure.

As described above with reference to FIG. 2, in some distributed hardware embodiments, Log Server 341 may distribute data packets and processing tasks related to the “Calls” log category to one or more selected physical machines, while distributing data packets and processing tasks related to the “Billing” log category to other physical machines in accordance with a predetermined load balancing strategy or algorithm. Alternatively, a load balancing strategy employed at each Log Server 341-343 may be dynamic, i.e. responsive to current processing overhead and residual load capacity at each physical machine.

As illustrated in FIG. 3, a server arrangement 300 may incorporate a dedicated database 345-347 associated with each log category; each database may be accessed by both the primary and the secondary servers for the associated log category. As an alternative, a single database may be employed for all the log report data acquired by each Log Server 341-343.

In contrast to broadcasting, which represents an abuse of network resources by indiscriminately transmitting data to physical machines on the network which do not require the data, multicasting generally does not adversely affect network data traffic at physical machines or hosts that are not specifically subscribed to a multicast group to which a data packet is published. Multicasting does, however, have an impact on the traffic experienced by network routers.

To minimize the penalty imposed on multicast routing, a system and method of multicast logging may utilize a specific range of values in the time-to-live (TTL) field in the IP packet header. Those of skill in the art will appreciate that the TTL field may define or control a particular data packet's geographic scope, i.e. the distance the packet may travel from its source or origin to its ultimate destination, or the number of server-to-server “hops” the packet is allowed to take before being discarded or returned to its source. The range for TTL values may generally vary to restrict the scope of a data packet to a local machine, for example, or to expand the scope to any desired extent. In an embodiment taking account of network router traffic, for example, a system and method of multicast logging may employ a TTL which defines a geographic scope for each data packet as encompassing only a local network.

As noted above, multicast reliability may be achieved through execution of any number of techniques known in the art, such as forward error correction (FEC), for example, or implementation of ACT based trees or NACK bases. Reliability may be selective in some embodiments as described above with reference to Log Viewer 250 in FIG. 2. For example, a multicast publisher may only identify reliable subscribers, while other, non-reliable subscribers such as Log Viewer 250 or other passive subscribers, for instance, gather log information without producing an appreciable impact on the publisher.

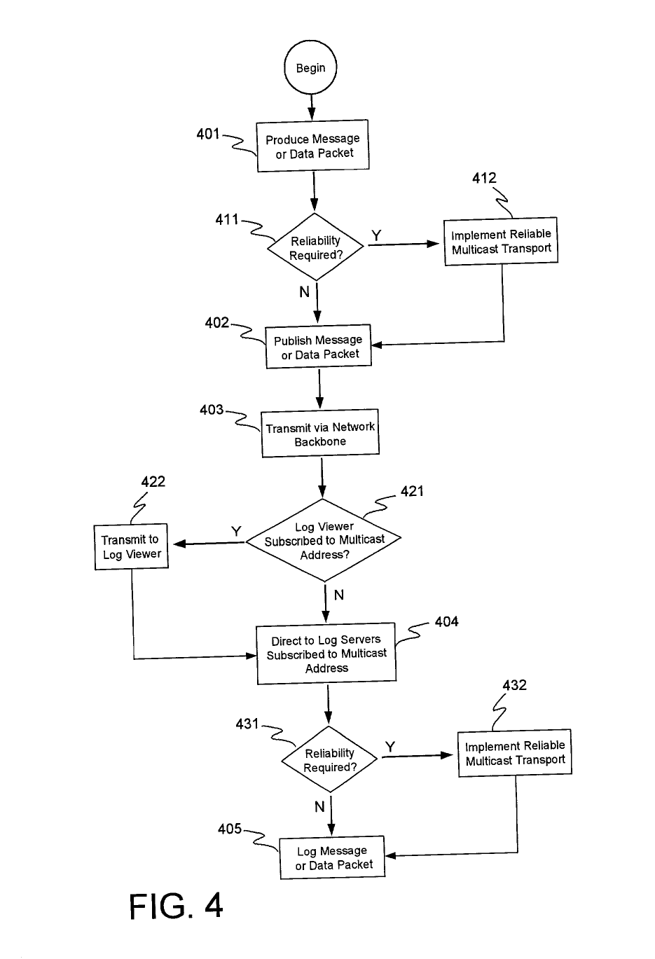

FIG. 4 is a simplified flow diagram illustrating one embodiment of a method of logging multicast data messages in a communication network. As indicated at block 401, a message or data packet containing a log report (or part thereof) to be multicast may be produced by an application program or a log client such as depicted at 221, 222 in FIG. 2. A system and method of multicast logging may determine if the data transmission must be reliable, as indicated at decision block 411; reliable transmission may be requested or required by an application creating the log report to be published, for example. At block 412, reliable multicast transport techniques, such as error detection and correction, for instance, may be implemented or requested by the publishing application to ensure reliable data transmission.

A message or data packet containing log report data may be published and transmitted across the network backbone as indicated at blocks 402 and 403. As set forth in detail above, multicast data may be published to one or more multicast addresses; upon transmission across the network at block 403, a data message or packet may ultimately be received by devices subscribing to one or more multicast addresses to which a data message is addressed. Various entities or devices (such as Log Viewer 250 and Log Servers 241, 242 in FIG. 2) may subscribe to such multicast addresses to receive all data transmitted thereto.

A log viewer, when included in a multicast logging system, may generally be a subscriber to at least one multicast address. A system and method of multicast logging may determine if such a log viewer is a subscriber to the address for a particular data packet at decision block 421, and subsequently route the data packet to the log viewer at block 422. Alternatively, a system and method of logging multicast data may simply forward data to every subscriber without making a determination as to the nature, composition, or categorization (i.e. log viewer or log server, for example) of the subscriber.

Log report data may be directed to log servers subscribed to the proper multicast address at block 404. Each log server subscribing to the multicast address may have independent reliability standards or requirements. As indicated at decision block 431, a reliability determination may be made such that reliable multicast transport techniques may be implemented as required (block 432) for each subscriber. Upon receipt at one or more log servers, data may be logged at block 405; such logging may generally correspond to that described in detail above with reference to FIGS. 2 and 3.

In accordance with another embodiment, the system architecture and functionality described above with reference to FIGS. 1-4 may be employed to transmit alarm messages using multicast transport techniques. In addition to, or as an alternative to, publishing log messages comprising non-critical or diagnostic data, clients (such as log clients 221 and 222, for example) may generate and multicast alarm messages comprising critical system data; such critical data may include or relate to overall system or component parameters or configurations, hardware or software failure at one or more clients, processing bandwidth complications, unacceptable performance characteristics of system components, monitored external parameters which exceed or fall short of predetermined thresholds, and the like. The foregoing list is exemplary only, and is not intended to be interpreted in any limiting sense; the system and method described herein are operative to accommodate alarm messages comprising any sort of critical system data.

System components (such as servers 241 and 242, for example) requiring real-time or near-real-time alarm data may subscribe to one or more particular multicast addresses to which the critical system data may be published, as set forth in detail above. Upon receipt of alarm messages containing critical data, system components may execute appropriate corrective action automatically, for example, or may promptly apprise an administrator of the alarm condition, for instance via a display such as viewer 250. Additionally, alarm messages and all critical data contained therein may be logged as described above, such as in database 245, for subsequent analysis and system diagnostics or maintenance procedures. Utilizing multicast transport techniques to publish alarm messages containing critical system data provides many of the same advantages as multicasting log messages containing diagnostic data.

The present invention has been illustrated and described in detail with reference to particular embodiments by way of example only, and not by way of limitation. Those of skill in the art will appreciate that various modifications to the disclosed embodiments are within the scope and contemplation of the invention. Therefore, it is intended that the invention be considered as limited only by the scope of the appended claims.

What is claimed is:

1. A method of logging multicast data messages in a communications network; said method comprising:
producing a log report containing data to be logged;
selectively implementing reliable multicast transport techniques; and
multicasting said log report to one or more multicast addresses in accordance with said producing and said selectively implementing.

2. The method of claim 1 further comprising:
identifying one or more subscribers to said one or more multicast addresses;
determining whether said one or more subscribers require reliable data; and
forwarding said log report to each of said one or more subscribers in accordance with said identifying and said determining.

3. The method of claim 1 wherein said selectively implementing includes receiving a request for reliable data transmission from an application producing said log report.

4. The method of claim 2 wherein said determining includes receiving a request for reliable data transmission from an application subscribing to said one or more multicast addresses.

5. The method of claim 1 wherein said producing, said selectively implementing, and said multicasting are implemented by a computer server.

6. The method of claim 5 wherein said identifying, said determining, and said forwarding are implemented by an additional computer server.

7. The method of claim 1 further comprising:
transmitting said log report to a log viewer for display of at least some information related to said log report.

8. The method of claim 2 further comprising:
identifying a log viewer as one of said one or more subscribers; and
transmitting said log report to said log viewer for display of at least some information related to said log report.

9. A multicast logging system comprising:
a log client publishing log reports to one or more multicast addresses on a communications network;
a log server subscribing to at least one of said one or more multicast addresses and receiving said log reports; and
a data storage medium receiving said log reports from said log server.

10. The system of claim 9 further comprising a log viewer subscribing to at least one of said one or more multicast addresses and allowing reception and display of information related to said log reports.

11. The system of claim 9 wherein said log client comprises a computer executable program application generating said log reports.

12. The system of claim 9 wherein said log server and said data storage medium are incorporated into a single physical machine.

13. The system of claim 9 wherein said log server comprises a plurality of distributed physical machines.

14. The system of claim 9 wherein said log client selectively implements reliable multicast transport techniques.

15. The system of claim 9 wherein said log server selectively implements reliable multicast transport techniques.

16. The system of claim 10 wherein said log viewer comprises a console application.

17. The system of claim 16 wherein said log viewer is incorporated into a World Wide Web browser application.

18. A computer readable medium encoded with data and computer executable instructions for transmitting a log report, the data and instructions causing an apparatus executing the instructions to:
produce a log report for publication to one or more multicast subscribers; said log report containing data to be logged;
selectively implement reliable multicast transport techniques; and
multicast said log report to said one or more multicast subscribers in accordance with said multicast transport techniques.

19. The computer readable medium of claim 18 further encoded with data and computer executable instructions, further causing an apparatus to receive a request for reliable data transmission from an application producing said log report.

20. The computer readable medium of claim 18 further encoded with data and computer executable instructions, further causing an apparatus to receive a request for reliable data transmission from said one or more multicast subscribers.

21. The computer readable medium of claim 18 further encoded with data and computer executable instructions, further causing an apparatus to:
transmit said log report a log viewer; and
request said log viewer to display information related to said log report.

22. A multicast logging system comprising:
a log client publishing log data to one or more multicast addresses on a communications network; and
a log viewer subscribing to at least one of said one or more multicast addresses and allowing reception and display of information related to said log data.

23. The system of claim 22 wherein said log client publishes said log data without using reliable multicast transport techniques.

24. The system of claim 22 wherein said log client comprises a computer executable program application generating said log data.

25. The system of claim 22 wherein said log viewer comprises a console application.

26. The system of claim 25 wherein said log viewer is incorporated into a World Wide Web browser application.

27. The system of claim 22 further comprising:
a log server subscribing to at least one of said one or more multicast addresses and receiving said log data; and
a data storage medium receiving said log data from said log server.

28. The system of claim 27 wherein said log server and said data storage medium are incorporated into a single physical machine.

29. The system of claim 27 wherein said log server comprises a plurality of distributed physical machines.

30. The system of claim 27 wherein said log client selectively implements reliable multicast transport techniques.

31. The system of claim 27 wherein said log server selectively implements reliable multicast transport techniques.

32. A method of logging multicast data messages in a communications network; said method comprising:
producing a message to be published to one or more multicast addresses; said message containing data to be logged;
determining whether said data must be reliable;
implementing reliable multicast transport techniques in accordance with said determining; and
publishing said data to said one or more multicast addresses in accordance with said determining and said implementing.

33. The method of claim 32 further comprising:
identifying one or more subscribers to said one or more multicast addresses;
ascertaining whether said one or more subscribers require said data to be reliable; and
forwarding said message to each of said one or more subscribers in accordance with said identifying and said ascertaining.

34. The method of claim 32 wherein said determining includes receiving a request for reliable data transmission from an application producing said message.

35. The method of claim 33 wherein said ascertaining includes receiving a request for reliable data transmission from an application subscribing to said one or more multicast addresses.

36. The method of claim 33 wherein said producing, said determining, and said publishing are implemented by a computer server.

37. The method of claim 36 wherein said identifying, said ascertaining, and said forwarding are implemented by an additional computer server.

38. The method of claim 32 further comprising:
providing a log viewer capable of receiving published data addressed to at least one of said one or more multicast addresses; and
displaying at least some of said published data received as a result of said providing.

39. An apparatus comprising:
a log client generating log reports; and
multicasting means for multicasting said log reports to one or more multicast addresses on a communications network.

40. The apparatus of claim 39 wherein said log client comprises a computer executable program application generating said log reports.

41. The apparatus of claim 39 wherein said log client and said multicasting means are incorporated into a single physical machine.

42. The apparatus of claim 39 wherein said multicasting means selectively implements reliable multicast transport techniques.

43. An apparatus comprising:
a log server subscribing to one or more multicast addresses and receiving log reports transmitted to said one or more multicast addresses; and
a data storage medium receiving said log reports from said log server.

44. The apparatus of claim 43 further comprising a log viewer subscribing to at least one of said one or more multicast addresses and allowing reception and display of information related to said log reports.

45. The apparatus of claim 43 wherein said log server and said data storage medium are incorporated into a single physical machine.

46. The apparatus of claim 43 wherein said log server comprises a plurality of distributed physical machines.

47. The apparatus of claim 43 wherein said log server selectively implements reliable multicast transport techniques.

48. The apparatus of claim 44 wherein said log viewer comprises a console application.

49. A method of multicasting alarm messages in a communications network; said method comprising:
producing an alarm report comprising critical system data;
selectively implementing reliable multicast transport techniques; and
multicasting said alarm report to one or more multicast addresses in accordance with said producing and said selectively implementing.

50. The method of claim 49 further comprising:
identifying one or more subscribers to said one or more multicast addresses;
determining whether said one or more subscribers require reliable data; and
forwarding said alarm report to each of said one or more subscribers in accordance with said identifying and said determining.

51. The method of claim 49 further comprising:
transmitting said alarm report to a viewer for display of at least some information related to said alarm report.

52. A multicast alarm system comprising:
a client publishing alarm reports to one or more multicast addresses on a communications network; and
a viewer subscribing to at least one of said one or more multicast addresses and allowing reception and display of information related to said alarm reports.

53. The system of claim 52 further comprising:
a server subscribing to at least one of said one or more multicast addresses and receiving said alarm reports; and
a data storage medium receiving said alarm reports from said server.

54. The system of claim 52 wherein said client comprises a computer executable program application generating said alarm reports.

55. The system of claim 53 wherein said server and said data storage medium are incorporated into a single physical machine.

56. The system of claim 53 wherein said server comprises a plurality of distributed physical machines.

57. The system of claim 52 wherein said client selectively implements reliable multicast transport techniques.

58. The system of claim 53 wherein said server selectively implements reliable multicast transport techniques.

59. The system of claim 52 wherein said viewer comprises a console application.
